(19) United States
(12) Patent Application Publication
(10) Pub. No.: US 2020/0379688 A1
(43) Pub. Date: Dec. 3, 2020

(54) IMAGE FORMING APPARATUS, IMAGE FORMING SYSTEM, AND METHOD FOR CONTROLLING IMAGE FORMING APPARATUS

(71) Applicant: KONICA MINOLTA, INC., Tokyo (JP)

(72) Inventors: Hiroshi SUGIURA, Toyokawa-shi (JP); Taro YAMAMOTO, Toyokawa-shi (JP)

(73) Assignee: KONICA MINOLTA, INC., Tokyo (JP)

(21) Appl. No.: 16/860,134

(22) Filed: Apr. 28, 2020

(30) Foreign Application Priority Data
May 28, 2019 (JP) 2019-099137

(51) Int. Cl. G06F 3/12

(52) U.S. Cl. CPC G06F 3/1203; G06F 3/1253

(57) ABSTRACT

An image forming apparatus includes: an operation panel that sets a type of a sheet loaded into a paper feed cassette; a sensor that detects the type of the sheet; and a controller that controls execution of a print job. When a sheet type set by the operation panel does not match a sheet type detected by the sensor and when a predetermined condition is met, the controller continues the print job at a setting corresponding to the sheet type detected by the sensor. When the predetermined condition is not met, the controller suspends the print job as a process when the sheet type set by the operation panel does not match the sheet type detected by the sensor.

The entire disclosure of Japanese Patent Application No. 2019-099137, filed on May 28, 2019, is incorporated herein by reference in its entirety.

### BACKGROUND

### Technological Field

The present disclosure relates to an image forming apparatus, an image forming system, and a method for controlling an image forming apparatus.

### Description of the Related Art

Image forming apparatuses such as a printer, a copying machine, a facsimile, and a multi-functional peripheral (MEP) thereof have been conventionally known.

In such image forming apparatuses, a user can set a type (kind) of sheets loaded into a paper feed cassette through an operation panel or a printer driver (hereinafter, referred to as “operation panel or the like”). There has also been known an image forming apparatus that automatically detects the type of the sheets by a media sensor provided at some midpoint in a transport path of the sheets.

In the image forming apparatus including the media sensor, a sheet type set through the operation panel or the like may in some cases be different from a sheet type detected by the media sensor.

In view of such a situation, a data processing apparatus described in, for example, Japanese Laid-Open Patent Publication No. 2005-62916 determines whether or not there is a mismatch between a paper (one kind of sheet) type detected by a media sensor and a paper type set by a printer driver, based on information obtained by a plurality of number of times of sensing of print data at different timings during processing. Furthermore, when determining that there is a mismatch, the data processing apparatus provides a warning indication and restricts generation of the print data and output of the generated print data. This prevents execution of printing that leads to a printing failure.

When a user loads sheets into a paper feed cassette, the user sets a type of the loaded sheets by an operation panel. However, some users are not interested in the type of the sheets (typically, paper), and thus, are uncertain about or not confident with what type of sheets are loaded. Such users typically set the type of the sheets provisionally (roughly) by the operation panel and activate the function of automatically detecting the type of the sheets (hereinafter, also referred to as “paper type automatic detection function).

In such a situation, as described above, a sheet type set through the operation panel or the like may in some cases be different from a sheet type detected by the media sensor. A typical method for dealing with this situation includes, for example, the following two methods.

(First Method)

The image forming apparatus causes the operation panel to display a warning indicating that the sheet type set on the operation panel is different from the sheet type detected by the media sensor. Furthermore, the image forming apparatus urges the user to change the setting of the sheet type on the operation panel, or to load another sheet into the paper feed cassette. Furthermore, the image forming apparatus ejects the fed sheet in a blank state to a tray different from a tray to which the sheet is normally ejected.

(Second Method)

The image forming apparatus changes the setting of the sheet type on the operation panel to the sheet type detected by the media sensor. In addition, the image forming apparatus also changes a print profile to a print profile corresponding to the sheet type detected by the media sensor, and continues the job.

However, if the image forming apparatus performs one of the above-described methods without exception, the user's convenience is lost. Such a case will be described below based on three specific examples.

### FIRST SPECIFIC EXAMPLE

Let us assume a case in which the user loads the sheets into the paper feed cassette, and immediately after that, the user starts a copy job. In this case, when the sheet type set on the operation panel is different from the sheet type detected by the media sensor at the time of feeding of a first sheet and when the sheet type detected by the media sensor meets a setting such as “staple”, it is desirable to apply the sheet type detected by the media sensor, continue the job and perform printing. This is because it is assumed that the user who has loaded the sheets into the paper feed cassette has instructed the copy job. Such a process is in line with the user's intention to use the sheets prepared and loaded by the user.

### SECOND SPECIFIC EXAMPLE

Next, let us assume a case in which the user loads the sheets into the paper feed cassette, and after a while, the user executes the copy job. In this case, when the sheet type set on the operation panel is different from the sheet type detected by the media sensor, it is desirable to display a warning indicating that the sheet types are different from each other, and eject the fed sheet in a blank state. This is because the user who has loaded the sheets into the paper feed cassette is not necessarily the same as the user who has instructed the copy job. In order to prevent printing from being performed on a different type of sheet, which leads to a miscopy, it is desirable that the user should check the sheets when the user starts the copy job while trusting the sheet type displayed on the operation panel.

### THIRD SPECIFIC EXAMPLE

Furthermore, let us assume a case in which after paper empty occurs, the user replenishes the paper feed cassette with sheets and the print process is restarted. In this case, when the sheet type set on the operation panel is different from the sheet type detected by the media sensor, it is desirable to display a warning indicating that the sheet types are different from each other, and eject the fed sheet in a blank state. This is because a miscopy printed on the different type of sheet may occur if the job is continued and printing is performed in line with the user's intention to use the sheets loaded by the user. Particularly, a user who is not interested in the sheet type does not always replenish the paper feed cassette with the same sheets consciously and may load sheets that the user can prepare by chance.

The present disclosure has been made in view of the above problem, and an object of the present disclosure is to provide an image forming apparatus, an image forming system, and a method for controlling an image forming apparatus, which are capable of performing a process in consideration of the user's intention when a sheet type set by an operation panel or the like is different from a sheet type detected by a sensor.

### SUMMARY

To achieve at least one of the abovementioned objects, according to an aspect of the present disclosure, an image forming apparatus reflecting one aspect of the present disclosure comprises: a paper feed cassette; an operation panel that sets a type of a sheet loaded into the paper feed cassette; a sensor that detects the type of the sheet; and a controller that controls execution of a print job. The controller determines whether or not a sheet type set by the operation panel matches a sheet type detected by the sensor. When determining that the sheet types do not match each other, the controller determines whether or not a predetermined condition is met. When the predetermined condition is met, the controller continues the print job at a setting corresponding to the sheet type detected by the sensor. When the predetermined condition is not met, the controller suspends the print job.

Preferably, when the predetermined condition is not met, the controller causes the operation panel to display a warning.

Preferably, the operation panel receives an operation for instructing a start of the print job. The predetermined condition is that the operation panel receives the operation for instructing the start of the print job, before a predetermined time period elapses after the sheet is loaded into the paper feed cassette and the sheet type is set by the operation panel.

Preferably, when the sheet is loaded into the paper feed cassette after the paper feed cassette becomes out of sheet, and the print job is restarted, the controller determines that the predetermined condition is not met.

Preferably, when the print job is a job of printing a plurality of number of copies in units of copies, the predetermined condition is that the paper feed cassette is replenished with the sheet from a state in which the paper feed cassette is empty, and the print job is restarted from the beginning of one of the copies.

Preferably, the controller performs user authentication. The predetermined condition is that it is determined as a result of the user authentication that a user who has set the sheet type by the operation panel is the same as a user who has instructed a start of the print job.

Preferably, the predetermined condition is that a combination of the sheet type detected by the sensor and a setting of the print job is not prohibited.

Preferably, the predetermined condition is that the sheet type detected by the sensor is plain paper.

Preferably, the image forming apparatus further includes a memory that stores data defining the sheet type based on a basis weight range. The predetermined condition is that a basis weight range of the sheet type set by the operation panel and a basis weight range of the sheet type detected by the sensor are continuous.

Preferably, the controller receives a setting of giving a higher priority to one of a setting of the sheet type by the operation panel and a result of detection of the sheet type by the sensor than to the other. The predetermined condition is that a setting of giving a higher priority to the result of detection of the sheet type by the sensor than to the setting of the sheet type by the operation panel is made.

Preferably, the image forming apparatus has, as setting modes, a first mode of executing the print job under condition of charging, and a second mode of executing the print job without condition of charging. The predetermined condition is that the setting mode is the second mode.

According to another aspect of the present disclosure, an image forming apparatus comprises: a paper feed cassette; an operation panel that sets a type of a sheet loaded into the paper feed cassette; a sensor that detects the type of the sheet; and a controller that executes a print job by a printer driver of an external information processing apparatus. The controller determines whether or not all of a sheet type set by the printer driver, a sheet type set by the operation panel, and a sheet type detected by the sensor match one another. When determining that all of the sheet types do not match one another, the controller determines whether or not a predetermined condition is met. When the predetermined condition is met, the controller continues the print job at a setting corresponding to the sheet type detected by the sensor. When the predetermined condition is not met, the controller suspends the print job. Preferably, when the predetermined condition is not met, the controller causes the operation panel to display a warning.

Preferably, the predetermined condition is that only two of all of the sheet types match each other and one remaining sheet type does not match the two.

Preferably, when the sheet type set by the printer driver, the sheet type set by the operation panel, and the sheet type detected by the sensor are different from one another, the controller determines that the predetermined condition is not met.

Preferably, the controller performs user authentication. The predetermined condition is that it is determined as a result of the user authentication that a user who has set the sheet type by the printer driver is the same as a user who has set the sheet type by the operation panel, and the sheet type set by the printer driver is different from the sheet type detected by the sensor.

According to still another aspect of the present disclosure, an image forming system comprises an image forming apparatus and an information processing apparatus. The information processing apparatus includes a printer driver for the image forming apparatus. The image forming apparatus includes: a paper feed cassette; an operation panel that sets a type of a sheet loaded into the paper feed cassette; a sensor that detects the type of the sheet; and a controller that executes a print job by the printer driver. The controller determines whether or not all of a sheet type set by the printer driver, a sheet type set by the operation panel, and a sheet type detected by the sensor match one another. When determining that all of the sheet types do not match one another, the controller determines whether or not a predetermined condition is met. When the predetermined condition is met, the controller continues the print job at a setting corresponding to the sheet type detected by the sensor. When the predetermined condition is not met, the controller suspends the print job.

According to a further aspect of the present disclosure, an image forming apparatus comprises: an operation panel; and a controller. The controller receives an input for setting a type of a sheet through the operation panel, even when a function of automatically detecting the type of the sheet is on.

Preferably, the image forming apparatus further comprises: a paper feed cassette that accommodates the sheet; and a sensor that automatically detects the type of the sheet. The operation panel receives a setting of the type of the sheet loaded into the paper feed cassette. The controller receives, through the operation panel, an input for turning on the function and an input for turning off the function.

According to a further aspect of the present disclosure, a method for controlling an image forming apparatus comprises: determining whether or not a sheet type set by an operation panel matches a sheet type detected by a sensor; when determining that the sheet types do not match each other, determining whether or not a predetermined condition is met; when the predetermined condition is met, continuing a print job at a setting corresponding to the sheet type detected by the sensor; and when the predetermined condition is not met, suspending the print job.

According to a further aspect of the present disclosure, a method for controlling an image forming apparatus comprises: determining whether or not all of a sheet type set by a printer driver of an information processing apparatus communicatively connected to the image forming apparatus, a sheet type set by an operation panel, and a sheet type detected by a sensor match one another; when determining that all of the sheet types do not match one another, determining whether or not a predetermined condition is met; when the predetermined condition is met, continuing a print job at a setting corresponding to the sheet type detected by the sensor; and when the predetermined condition is not met, suspending the print job.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the present disclosure.

FIG. 1 shows an overall configuration of a network system.

FIG. 2 is a schematic diagram showing an internal structure of an image forming apparatus.

FIG. 3 is a block diagram for illustrating an example hardware configuration of the image forming apparatus.

FIG. 4 shows an outer appearance of an operation panel.

FIG. 5 shows an example screen displayed on a touch screen.

FIG. 6 shows data stored in a controller.

FIG. 7 is a block diagram for illustrating a functional configuration of the image forming apparatus.

FIG. 8 is a flowchart for illustrating a first process example.

FIG. 9 is a flowchart for illustrating a second process example.

FIG. 10 is a flowchart for illustrating a third process example.

FIG. 11 is a flowchart for illustrating a fourth process example.

FIG. 12 is a diagram for illustrating data.

FIG. 13 is a flowchart for illustrating a fifth process example.

FIG. 14 is a flowchart for illustrating a sixth process example.

FIG. 15 shows an example operation screen of an administrator setting.

FIG. 16 is a flowchart for illustrating a seventh process example.

FIG. 17 is a flowchart for illustrating an eighth process example.

FIG. 18 shows a setting screen of a printer driver displayed on a PC.

FIG. 19 is a flowchart for illustrating a ninth process example.

### DETAILED DESCRIPTION OF EMBODIMENTS

Hereinafter, one or more embodiments of the present disclosure will be described with reference to the drawings. However, the scope of the disclosure is not limited to the disclosed embodiments.

An image forming apparatus in an embodiment will be described below with reference to the drawings. When the number, an amount or the like is mentioned in the embodiment described below, the scope of the present disclosure is not necessarily limited to that number, that amount or the like unless otherwise specified. The same or corresponding components are denoted by the same reference numerals and redundant description will not be repeated.

Some parts of the drawings are shown not in accordance with the ratio of the actual dimensions but with the ratio being changed to clarify the structure for easier understanding of the structure. The embodiments and modifications described below may be selectively combined as appropriate.

Although the image forming apparatus is described below as a color printer, the image forming apparatus is not limited to the color printer. The image forming apparatus may be, for example, a monochrome printer, or may be a facsimile, or may be a multi-functional peripheral (MFP) of a monochrome printer, a color printer and a facsimile.

In the following description, “print job” includes a copy job when performing copying in the image forming apparatus, and a job based on a print command from a terminal device (typically, a personal computer) communicatively connected to the image forming apparatus.

### A. SYSTEM CONFIGURATION

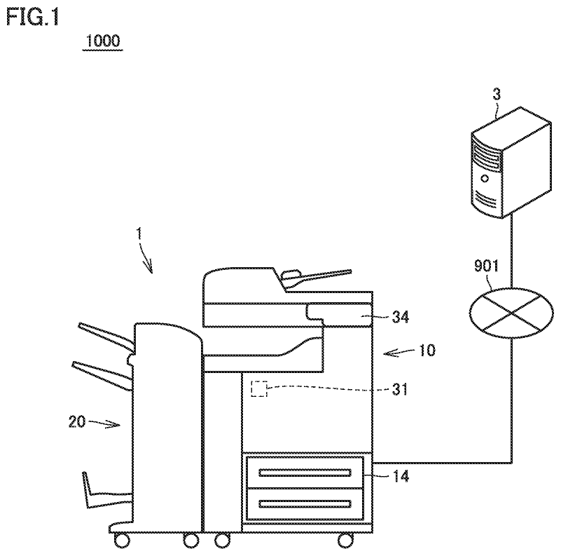

FIG. 1 shows an overall configuration of a network system 1000.

Referring to FIG. 1, network system 1000 includes an image forming apparatus 1 and a PC (Personal Computer) 3.

Image forming apparatus 1 is communicatively connected to PC 3 through a network 901. Image forming apparatus 1 includes a main body 10 and a postprocessor 20. Main body 10 includes a controller (control board) 31, an operation panel 34 and a paper feed cassette 14.

PC 3 is a user terminal. By operating PC 3, the user allows image forming apparatus 1 to execute various jobs. Specifically, PC 3 includes a printer driver for the image forming apparatus.

PC 3 and image forming apparatus 1 may be communicatively connected to a server (not shown).

### B. CONFIGURATION OF IMAGE FORMING APPARATUS 1

### b1. Internal Structure

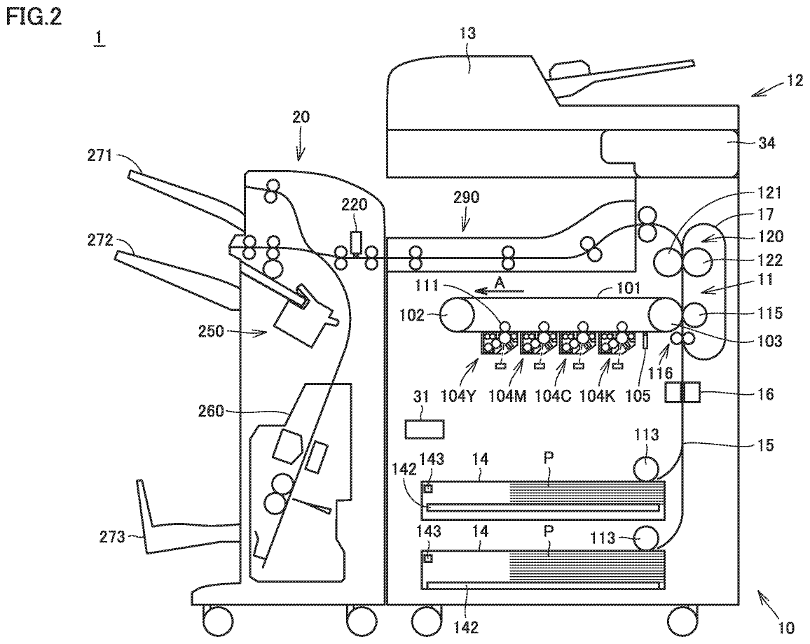

FIG. 2 is a schematic diagram showing an internal structure of image forming apparatus 1. Referring to FIG. 2, image forming apparatus 1 includes main body 10 and postprocessor 20 as described above.

Main body 10 includes an image forming unit 11, a scanner unit 12, an automatic original transport unit 13, two paper feed cassettes 14, a transport path 15, a media sensor 16, a reverse transport path 17, operation panel 34, and paper feed rollers 113. The automatic original transport unit will also be referred to as “ADF (auto document feeder)”.

Main body 10 further includes a controller 31, which controls an operation of image forming apparatus 1. In the present embodiment, main body 10 is a so-called tandem color printer. Main body 10 performs image formation based on print settings.

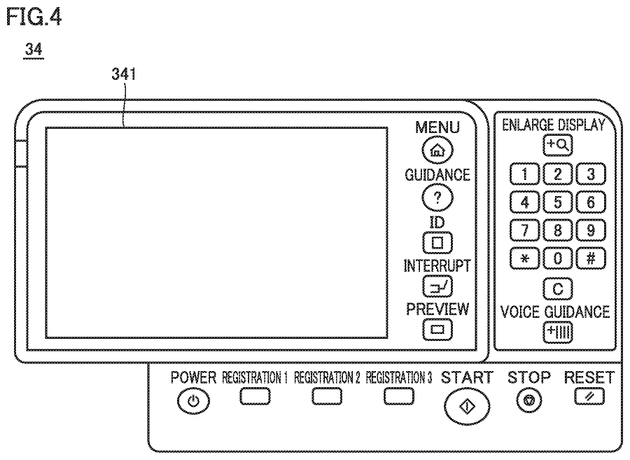

Automatic original transport unit 13 automatically transports an original placed on a platen to a scanning position of an original scanning unit. Scanner unit 12 scans an image of the original transported by automatic original transport unit 13 and generates image data. Scanner unit 12 also scans the image of the original placed on the platen by the user without using automatic original transport unit 13 and generates image data. The image data of the original generated by scanner unit 12 is stored in a memory (typically, a fixed storage 32 shown in FIG. 4).

Paper feed cassettes 14 accommodate sheets such as sheets of paper P. Paper feed roller 113 sends sheets of paper P upward along transport path 15 in the case of the example shown in FIG. 2. Each paper feed cassette 14 includes a bottom raising plate 142 and a sensor 143. Sensor 143 senses a position of a restriction plate (not shown) in the paper feed cassette and senses a paper size. Examples of the sheets other than the sheets of paper include an envelope, an OHP (Overhead projector) film and the like.

Transport path 15 is used in single-sided printing and double-sided printing. Reverse transport path 17 is used in double-sided printing.

Image forming unit 11 performs image formation on sheets of paper P supplied from paper feed cassettes 14 based on the image data generated by scanner unit 12 or print data obtained from PC 3.

Image forming unit 11 includes an intermediate transfer belt 101, a tension roller 102, a driving roller 103, a yellow image forming portion 104Y, a magenta image forming portion 104M, a cyan image forming portion 104C, a black image forming portion 104K, an image density sensor 105, a primary transfer device 111, a secondary transfer device 115, a pair of resist rollers 116, and a fixing device 120 formed of a heating roller 121 and a pressure roller 122. Intermediate transfer belt 101 is held by tension roller 102 and driving roller 103, and intermediate transfer belt 101 is rotationally driven in a direction of A in FIG. 2. The pair of resist rollers 116 transport more downstream sheets of paper P transported by paper feed rollers 113.

Media sensor 16 is provided on transport path 15. Media sensor 16 implements a paper type automatic detection function (function of automatically detecting a paper type). Media sensor 16 is provided between paper feed rollers 113 and pair of resist rollers 116.

Media sensor 16 is, for example, an optical sensor including a light emitting portion that emits light to a sheet of paper, and a light receiving portion that receives light reflected from the sheet of paper. The optical sensor serving as media sensor 16 determines a paper basis weight based on a voltage value of the received light. Examples of media sensor 16 include a displacement sensor that detects a thickness of a sheet of paper, a capacitance sensor that detects an amount of water contained in a sheet of paper, a camera that picks up an image of a surface of a sheet of paper, an ultrasonic sensor that detects properties of a sheet of paper, and the like. Typically, when sheets of paper are loaded into paper feed cassette 14 and then a first sheet of paper is fed from paper feed cassette 14, a paper type is determined by media sensor 16.

The information about the basis weight is transmitted from media sensor 16 to controller. Thus, controller 31 determines the paper type based on data D6 described below.

Postprocessor 20 further includes a punching device 220, a side stitching portion 250, a saddle stitching portion 260, a paper ejection tray 271, a paper ejection tray 272, and a paper ejection tray 273 which is located in the lower portion thereof.

### b2. Hardware Configuration

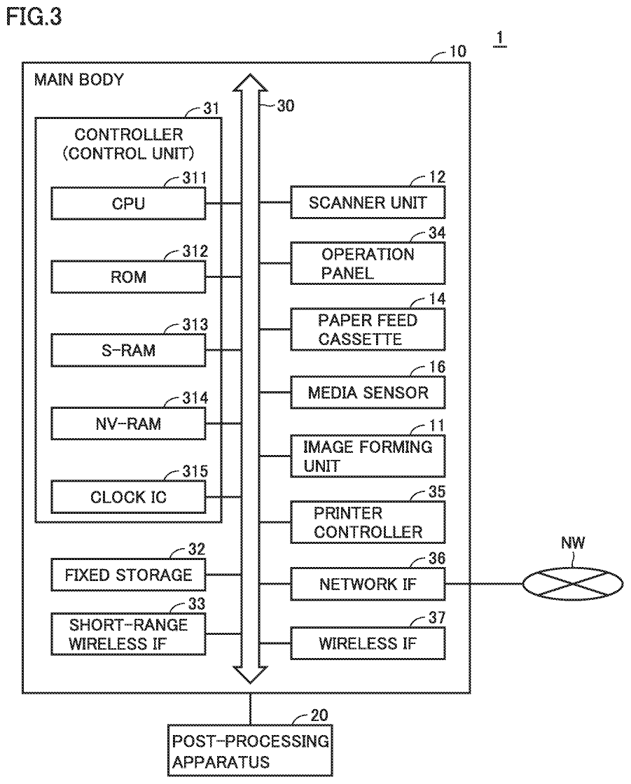

FIG. 3 is a block diagram for illustrating an example hardware configuration of image forming apparatus 1.

Referring to FIG. 3, main body 10 includes controller 31, fixed storage 32, a short-range wireless interface (IF) 33, scanner unit 12, operation panel 34, paper feed cassettes 14, media sensor 16, image forming unit 11, a printer controller 35, a network IF 36, and a wireless IF 37. Controller 31 is connected with the components 11, 12, 14, 16, and 32 to 37 through a bus 30.

Controller 31 controls an operation of image forming apparatus 1. Controller 31 includes a central processing unit (CPU) 311, a read only memory (ROM) 312 storing a control program, a static random access memory (S-RAM) 313 for work, a battery-backed-up non-volatile RAM (NV-RAM: nonvolatile memory) 314 for storing various settings regarding image formation, and a clock integrated circuit (IC) 315. The components 311 to 315 are connected through bus 30. Controller 31 is typically built into main body 10 as a control board.

Operation panel 34 includes keys for various inputs and a display. Operation panel 34 is typically composed of a touch screen and a hardware key. The touch screen is a device in which a touch panel is placed on a display.

Network IF 36 transmits and receives various types of information to and from external apparatuses such as PC 3, the server (not shown) and another image forming apparatus (not shown) connected through the network.

Printer controller 35 generates a copy image from print data received through network IF 36. Image forming unit 11 forms a copy image on the sheet of paper.

Fixed storage 32 is typically a hard disk device. Fixed storage 32 stores various types of data. Fixed storage 32 may be a flash memory.

### b3. Operation Panel

FIG. 4 shows an outer appearance of operation panel 34. Referring to FIG. 4, operation panel 34 includes a touch screen 341 and a plurality of physical keys. In the present embodiment, touch screen 341 has such a structure that a touch panel is placed on a display.

A screen is displayed on touch screen 341. An operation screen is displayed on touch screen 341. The operation screen is, for example, a setting screen. In an aspect, one operation screen includes at least one operation button. The operation button is also referred to as “software key”, “software button”, “selectable object”, or “icon”. By operating the operation button, the user of image forming apparatus 1 can set an item or change a currently set item.

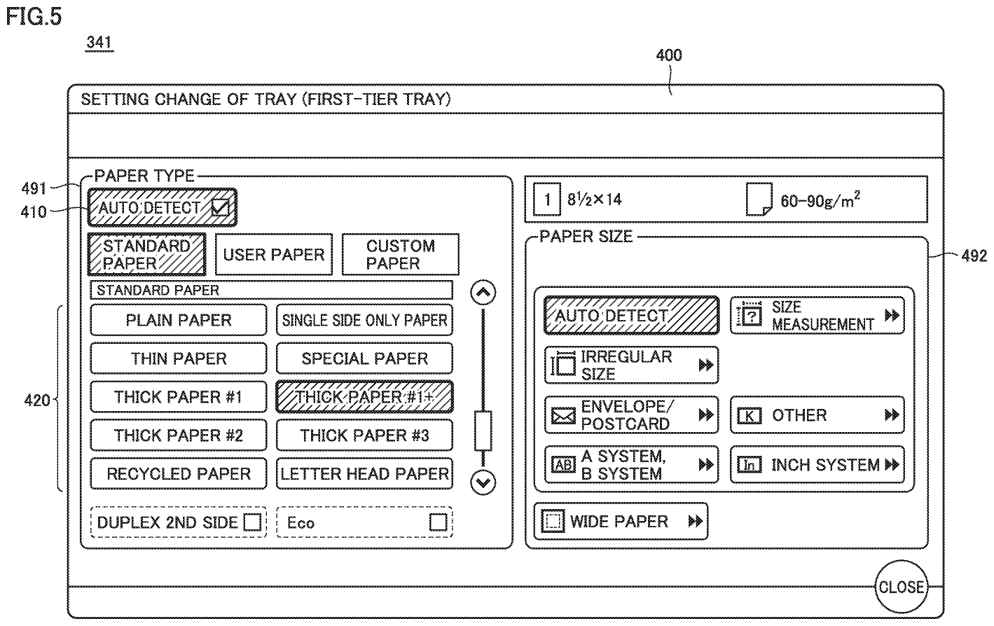

FIG. 5 shows an example screen displayed on touch screen 341.

Referring to FIG. 5, controller 31 causes touch screen 341 to display a screen 400 for setting change of a tray (paper feed cassette 14). In the present embodiment, a screen for setting change of upper paper feed cassette 14, of two paper feed cassettes 14, is shown.

Screen 400 includes a setting item 491 about a paper type, and a setting item 492 about a paper size. Setting item 491 includes an object image 410 for setting on (activation) and off (deactivation) of the function of automatically detecting the paper type by media sensor 16 (i.e., paper type automatic detection function).

Setting item 491 also includes a group of object images 420 for selecting the paper type. In the example in FIG. 5, “plain paper”, “single side only paper”, “thin paper”, “special paper”, “thick paper #1”, “thick paper #1+”, “thick paper #2”, “thick paper #3”, “recycled paper”, and “letter head paper” are shown as the object images. In addition, in the example in FIG. 5, the object image of “thick paper #1+” is selected by the user.

As described above, image forming apparatus 1 (specifically, controller 31) receives, through operation panel 34, an input for turning on the paper type automatic detection function of detecting the paper type, and an input for turning off the paper type automatic detection function. Even in a state in which the paper type automatic detection function is on, image forming apparatus 1 receives, through operation panel 34, an input for setting the paper type (input for selecting an object image from the group of object images 420).

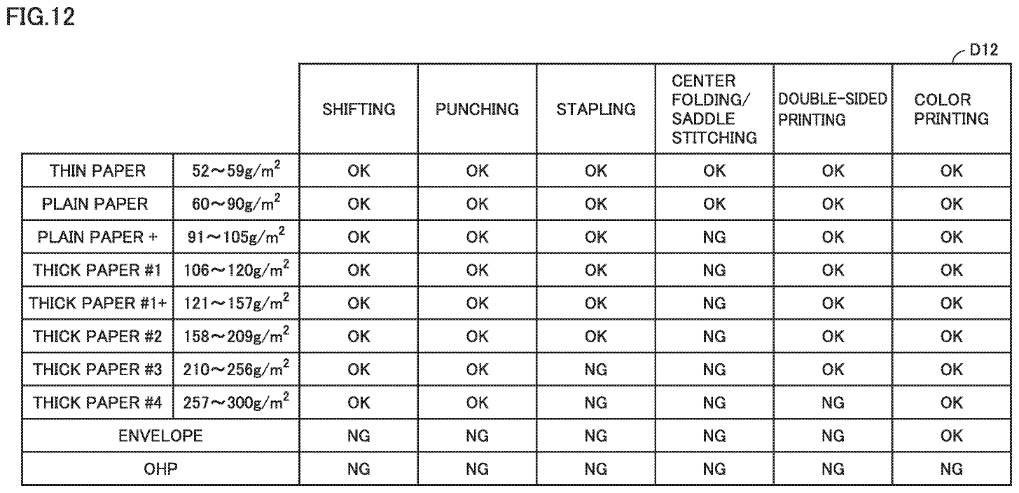

With such a configuration, controller 31 can determine whether or not a prohibition rule is applied, before the paper type is detected by media sensor 16. Specifically, when only media sensor 16 operates, image forming apparatus 1 does not know the paper type until the paper type is specified. Therefore, image forming apparatus 1 executes the job regardless of whether or not a combination of a print setting of the job and a transported sheet of paper satisfies the prohibition rule. When the combination actually satisfies the prohibition rule, image forming apparatus 1 is forced to suspend the job, which causes a problem of wasting the time required for the job and the sheet of paper. However, the above-described problem is solved because image forming apparatus 1 receives, through operation panel 34, the input for setting the paper type, even in the state in which the paper type automatic detection function is on. Specific examples of the prohibition rule will be described below (FIG. 12).

On and off of the paper type automatic detection function can be set for each paper feed cassette 14 (in the present embodiment, first-tier (upper) paper feed cassette 14 and second-tier (lower) paper feed cassette 14). Even in such a case, in each of the screens for setting change of the plurality of paper feed cassettes 14, image forming apparatus 1 receives the input for setting the paper type (input for selecting an object image from the group of object images 420), regardless of whether the paper type automatic detection function is on or off.

### b4. Data

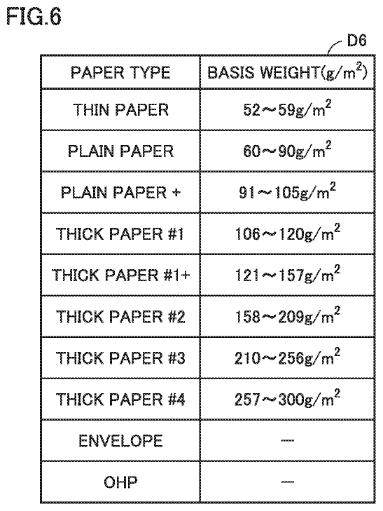

FIG. 6 shows data D6 stored in controller 31.

Referring to FIG. 6, data D6 shows a relationship between a paper type and a basis weight (g/m²). Data D6 is data that defines a paper type based on a basis weight range.

For example, in the present embodiment, “thin paper” is defined as paper having a basis weight of not less than 52 g/m² and not more than 59 g/m². “Plain paper” is defined as paper having a basis weight of not less than 60 g/m² and not more than 90 g/m².

Similarly, “plain paper +”, “thick paper #1”, “thick paper #1+”, “thick paper #2”, “thick paper #3”, and “thick paper #4” are defined as paper having a basis weight of not less than 91 g/m² and not more than 105 g/m², paper having a basis weight of not less than 106 g/m² and not more than 120 g/m², paper having a basis weight of not less than 121 g/m² and not more than 157 g/m², paper having a basis weight of not less than 158 g/m² and not more than 209 g/m², paper having a basis weight of not less than 210 g/m² and not more than 256 g/m², and paper having a basis weight of not less than 257 g/m² and not more than 300 g/m², respectively.

### b5. Functional Configuration

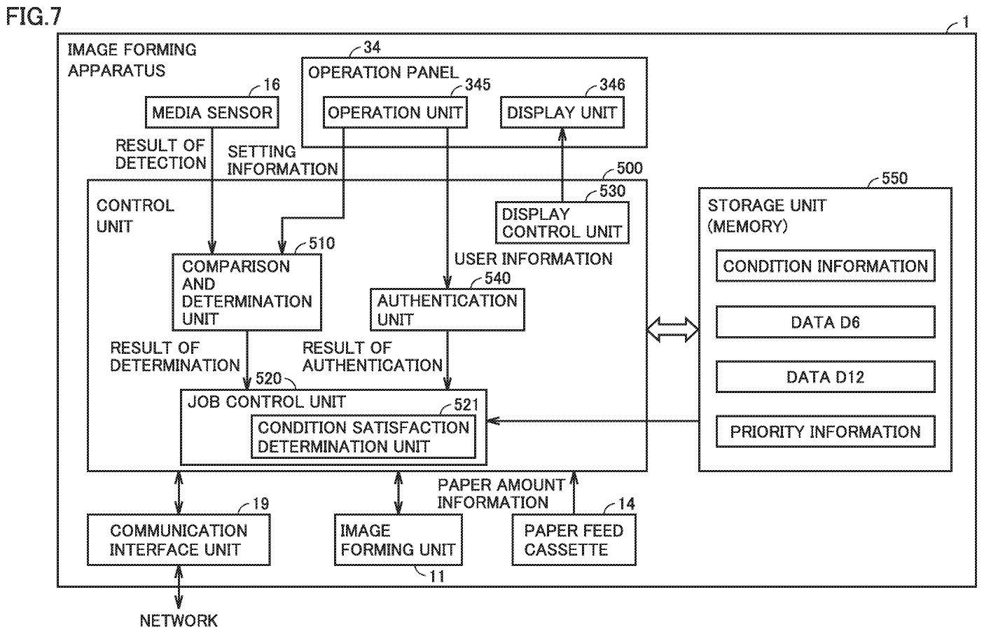

FIG. 7 is a block diagram for illustrating a functional configuration of image forming apparatus 1.

Referring to FIG. 7, image forming apparatus 1 includes a control unit 500, a storage unit 550, media sensor 16, operation panel 34, a communication interface unit 19, image forming unit 11, and paper feed cassette 14.

Operation panel 34 includes an operation unit 345 and a display unit 346. Operation unit 345 corresponds to the touch panel and the physical keys. Display unit 346 corresponds to the display.

Paper feed cassette 14 transmits information about paper empty to control unit 500. Control unit 500 can thereby know whether or not paper feed cassette 14 becomes empty of paper (the paper feed cassette becomes out of paper).

Communication interface unit 19 is an interface for communicating with PC 3 and the like. Communication interface unit 19 corresponds to network IF 36 and wireless IF 37 (FIG. 3).

Storage unit 550 stores above-described data D6 (see FIG. 6), below-described data D12 (see FIG. 12), condition information indicating a predetermined condition, and priority information.

Control unit 500 controls an overall operation of image forming apparatus 1. Control unit 500 corresponds to controller 31. Control unit 500 is typically implemented by CPU 311 (see FIG. 3) executing an OS (Operating System) and a program.

Control unit 500 includes a comparison and determination unit 510, a job control unit 520, a display control unit 530, and an authentication unit 540. Job control unit 520 includes a condition satisfaction determination unit 521.

Display control unit 530 causes display unit 346 to display various images. For example, display control unit 530 causes display unit 346 to display above-described screen 400, the below-described warning indication and the like.

A process using authentication unit 540 and a result of authentication by authentication unit 540 will be described below.

Comparison and determination unit 510 obtains a result of detection by media sensor 16. Comparison and determination unit 510 also obtains information (setting information) about the paper type set by operation unit 345.

Comparison and determination unit 510 determines whether or not the result of detection matches the setting information. That is, comparison and determination unit 510 determines whether or not a paper type set through operation panel 34 matches a paper type detected by media sensor 16. Comparison and determination unit 510 provides a notification about a result of determination to job control unit 520. Specifically, comparison and determination unit 510 provides, to job control unit 520, a notification about one of the information indicating that the paper types match each other and the information indicating that the paper types do not match each other.

When comparison and determination unit 510 determines that the sheet types do not match each other, condition satisfaction determination unit 521 of job control unit 520 determines whether or not the above-described predetermined condition is met (satisfied).

When the predetermined condition is met, job control unit 520 continues the print job at a setting corresponding to the paper type detected by media sensor 16, as a process when the paper type set by operation panel 34 does not match the paper type detected by media sensor 16. In contrast, when the predetermined condition is not met, job control unit 520 suspends the print job as a process when the paper type set by operation panel 34 does not match the paper type detected by media sensor 16.

As described above, the predetermined condition is used to determine whether to continue the job or to suspend the job. Specific examples of the predetermined condition will be described together with various process examples described below.

### C. PROCESS EXAMPLES

In each process example described below, the paper type automatic detection function is on. In first to eighth process examples, a case in which the print job is the copy job will be described. In a ninth process example, a case in which the print job is the above-described job based on the print command will be described.

### c1. First Process Example

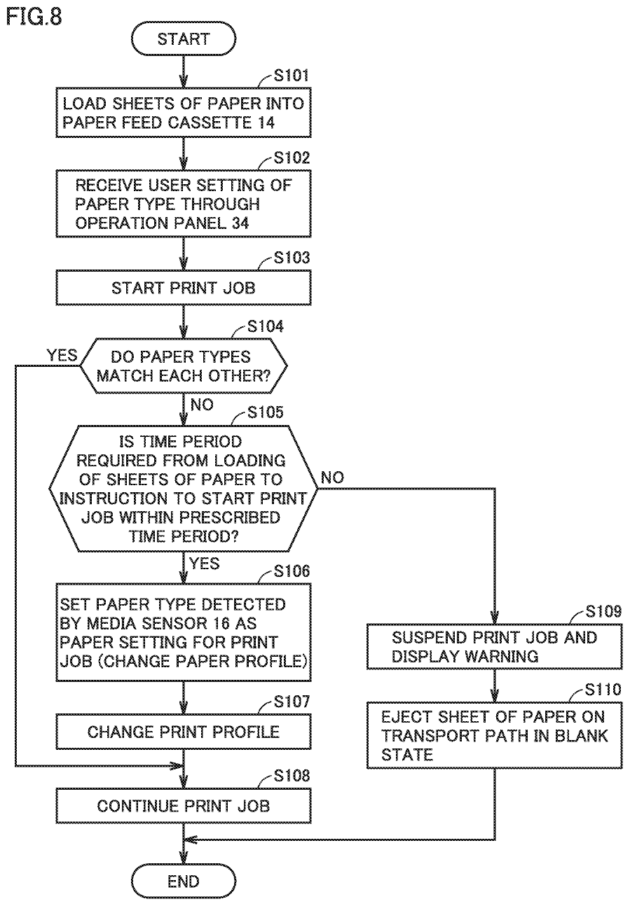

FIG. 8 is a flowchart for illustrating a first process example.

Referring to FIG. 8, in step S101, the user loads sheets of paper into paper feed cassette 14. In step S102, image forming apparatus 1 receives a user setting of a paper type at operation panel 34 (see FIG. 5).

In step S103, when image forming apparatus 1 receives a user operation for instructing a start of the print job (specifically, the copy job), image forming apparatus 1 starts the print job. In step S104, controller 31 (specifically, comparison and determination unit 510) determines whether or not a paper type set by operation panel 34 matches a paper type detected by media sensor 16.

When it is determined that the paper types match each other (YES in step S104), controller 31 moves the process to step S108. When it is determined that the paper types do not match each other (NO in step S104), controller 31 determines whether or not the predetermined condition is met in step S105. Specifically, in step S105, controller 31 determines whether or not a time period required from the loading of the sheets of paper to the instruction to start the print job is within a prescribed time period (within a predetermined time period). That is, controller 31 determines whether or not the process from step S101 to step S103 has been performed within the prescribed time period.

When it is determined that the time period is within the prescribed time period (i.e., it is determined that the predetermined condition is met) (YES in step S105), controller 31 sets the paper type detected by media sensor 16 as a paper setting for the print job in step S106. That is, controller 31 changes a paper profile. Thereafter, in step S107, controller 31 changes a print profile to the contents corresponding to the paper profile. In step S108, controller 31 continues the print job.

When it is determined that the time period is not within the prescribed time period (NO in step S105), controller 31 moves the process to step S109. In step S109, controller 31 suspends the print job and causes operation panel 34 to display the warning.

The warning typically includes a message that causes the user to perform the subsequent process. When the warning is displayed, the user takes the measure of continuing the print job at the setting corresponding to the paper type detected by media sensor 16 (i.e., changing the setting of the paper type set by operation panel 34), the measure of changing the sheets of paper loaded into paper feed cassette 14, or the measure of using another paper feed cassette 14. Thereafter, image forming apparatus 1 performs a process corresponding to the user's measure.

At this time, as shown in step S110, image forming apparatus 1 ejects, in a blank state, a sheet of paper (sheet of paper on the transport path), which was fed from paper feed cassette 14 in order to automatically detect the paper type, to a tray different from a tray to which the sheet of paper is normally ejected.

As described above, in this example, the print job is continued when the positive determination is made in step S105, and the print job is suspended and the warning is displayed when the negative determination is made in step S105.

(Intention of Process)

When the time period required from the loading of the sheets of paper to the instruction to start the copy job is short, a user who has loaded the sheets of paper is considered to be the same as a user who has instructed the start of the copy job. In this case, image forming apparatus 1 determines that the user wants to use the sheets of paper prepared and loaded by the user, and continues the job. Specifically, activation of the paper type automatic detection function by the user indicates that the user has a desire to perform printing on the sheets of paper loaded by the user at an optimum print profile, and thus, image forming apparatus 1 continues the job.

In contrast, when the time period required from the loading of the sheets of paper to the instruction to start the copy job is long, the user who has loaded the sheets of paper is not necessarily considered to be the same as the user who has instructed the start of the copy job. In this case, another user who trusts the paper type displayed on operation panel 34 may have started the copy job. Therefore, in this case, image forming apparatus 1 causes operation panel 34 to display the warning, in order to prevent a miscopy on a priority basis.

### c2. Second Process Example

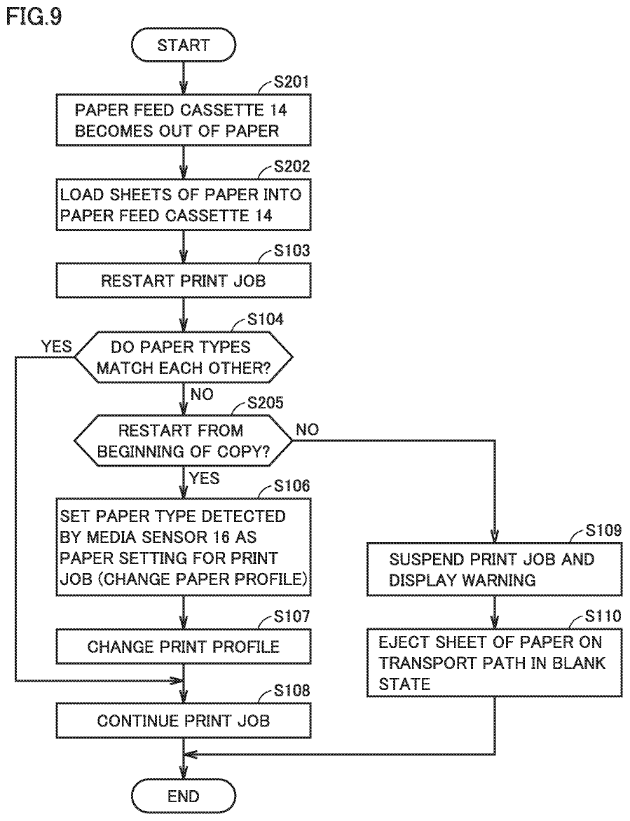

FIG. 9 is a flowchart for illustrating a second process example. The second process example shows a case in which paper feed cassette 14 becomes empty of paper (paper feed cassette 14 becomes out of paper).

Referring to FIG. 9, when it is detected that paper feed cassette 14 becomes empty of paper (step S201), the user loads sheets of paper into paper feed cassette 14 in step S202.

In step S103, when image forming apparatus 1 receives a user operation for instructing a start of the print job (specifically, the copy job), image fanning apparatus 1 starts the print job. In step S104, controller 31 (specifically, comparison and determination unit 510) determines whether or not a paper type set by operation panel 34 matches a paper type detected by media sensor 16.

When it is determined that the paper types match each other (YES in step S104), controller 31 moves the process to step S108. When it is determined that the paper types do not match each other (NO in step S104), controller 31 determines whether or not the predetermined condition is met in step S205. Specifically, in step S205, when the print job is a job of printing a plurality of number of copies in units of copies, controller 31 determines whether or not the print job is restarted from the beginning of one of the copies.

For example, when paper feed cassette 14 becomes out of paper while the user is making only three copies of the contents of 10 pages, controller 31 determines whether or not the print job is restarted from the beginning of a second copy (i.e., an eleventh sheet) or the beginning of a third copy (i.e., a twenty-first sheet).

When it is determined that the print job is restarted from the beginning of one of the copies (i.e., it is determined that the predetermined condition is met) (YES in step S205), controller 31 moves the process to step S106. When it is not determined that the print job is restarted from the beginning of one of the copies (NO in step S205), controller 31 moves the process to step S109. Since the subsequent process is similar to that of the first process example, description will not be repeated.

As described above, in this example, the print job is continued when the positive determination is made in step S205, and the print job is suspended and the warning is displayed when the negative determination is made in step S205.

(Intention of Process)

When paper feed cassette 14 becomes out of paper (paper empty occurs), the user replenishes paper feed cassette 14 with sheets of paper in a state in which the warning screen indicating that paper feed cassette 14 is out of paper is displayed on operation panel 34. When replenishment of the sheets of paper is completed, paper feeding is automatically restarted. In this case, the work of resetting the paper type on operation panel 34 is unnecessary. Therefore, the paper type set on operation panel 34 does not change before and after paper feed cassette 14 becomes out of paper. However, only when paper feed cassette 14 is replenished with a different type of sheets of paper, a difference occurs between the paper type set by operation panel 34 and the paper type detected by media sensor 16.

Thus, a difference in a result of comparison between the paper types indicates that different types of sheets of paper are used before and after paper feed cassette 14 becomes out of paper. Therefore, a miscopy printed on the different type of sheet of paper may be output. Accordingly, image forming apparatus 1 causes operation panel 34 to display the warning, to thereby leave a judgment to the user.

However, when the print job is restarted from the beginning of one of the copies after paper feed cassette 14 is replenished with the sheets of paper (i.e., YES in step S205), a miscopy printed on the different type of sheet of paper is not output. Therefore, the job may be continued at a setting corresponding to the type of the replenished sheets of paper (paper type detected by media sensor 16).

When prevention of paper type mixing among the plurality of number of copies is also desired, controller 31 may be configured to cause operation panel 34 to display the warning without exception.

(Modification)

Image forming apparatus 1 may be configured to cause operation panel 34 to display the warning when the sheets of paper are loaded into paper feed cassette 14 after paper feed cassette 14 becomes out of paper, and the print job is restarted, regardless of whether the print job is restarted from the beginning of one of the copies or from the middle of one of the copies. That is, controller 31 may be configured to determine that the predetermined condition is not met when the sheets of paper are loaded into paper feed cassette 14 after paper feed cassette 14 becomes out of paper, and the print job is restarted.

### c3. Third Process Example

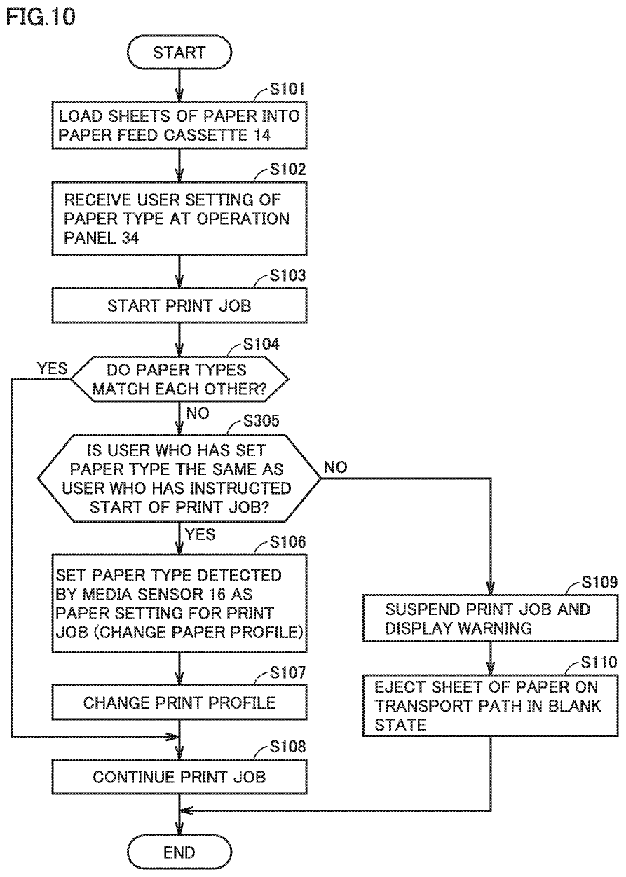

FIG. 10 is a flowchart for illustrating a third process example.

Referring to FIG. 10, the third process example is different from the first process example in that the third process example includes step S305 instead of step S105. Therefore, in the following description, attention will be focused on step S305 and description of the remaining steps will not be repeated.

When it is determined that the paper type set by operation panel 34 does not match the paper type detected by media sensor 16 (NO in step S104), controller 31 determines whether or not the predetermined condition is met in step S305. Specifically, in step S305, controller 31 determines whether or not a user who has set the paper type by operation panel 34 is the same as a user who has instructed the start of the print job.

The determination as to whether or not the users are the same is made by authentication unit 540 (see FIG. 7). The determination (i.e., authentication) by authentication unit 540 is typically made as follows. First, controller 31 holds, in a user authentication function, login information when setting the paper type on operation panel 34 after the sheets of paper are loaded into paper feed cassette 14. Thereafter, controller 31 compares the login information when setting the paper type on operation panel 34 with login information when executing the print job, to thereby determine whether or not the users are the same.

When it is determined that the users are the same (i.e., it is determined that the predetermined condition is met) (YES in step S305), controller 31 moves the process to step S106. When it is determined that the users are not the same (NO in step S305), controller 31 moves the process to step S109. Since the subsequent process is similar to that of the first process example, description will not be repeated.

As described above, in this example, the print job is continued when the positive determination is made in step S305, and the print job is suspended and the warning is displayed when the negative determination is made in step S305.

(Intention of Process)

When the user who has loaded the sheets of paper into paper feed cassette 14 is the same as the user who has instructed the start of the print job, controller 31 determines that the user wants to use the sheets of paper prepared and loaded by the user, and continues the job.

In contrast, when the user who has loaded the sheets of paper into paper feed cassette 14 is different from the user who has instructed the start of the print job, the user may have started the print job while trusting the paper type displayed on operation panel 34. Therefore, image forming apparatus 1 causes operation panel 34 to display the warning, in order to prevent a miscopy on a priority basis.

### c4. Fourth Process Example

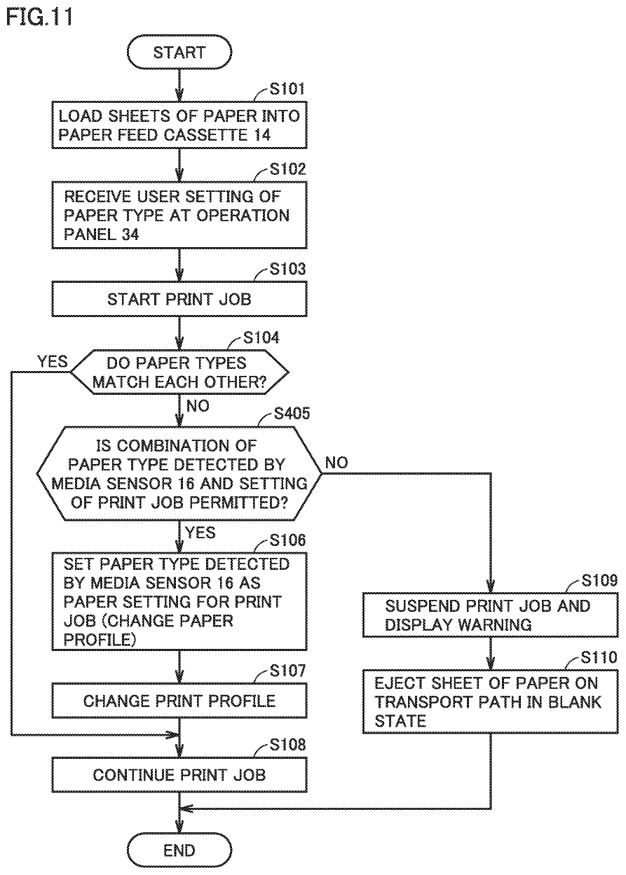

FIG. 11 is a flowchart for illustrating a fourth process example.

Referring to FIG. 11, the fourth process example is different from the first process example in that the fourth process example includes step S405 instead of step S105. Therefore, in the following description, attention will be focused on step S405 and description of the remaining steps will not be repeated.

When it is determined that the paper type set by operation panel 34 does not match the paper type detected by media sensor 16 (NO in step S104), controller 31 determines whether or not the predetermined condition is met in step S405. Specifically, in step S405, controller 31 determines whether or not a combination of the paper type detected by media sensor 16 and the setting of the print job is permitted. Specifically, controller 31 determines whether or not the combination is prohibited, based on data D12 described below (see FIG. 12).

When it is determined that the combination is permitted (i.e., it is determined that the predetermined condition is met) (YES in step S405), controller 31 moves the process to step S106. When it is determined that the combination is not permitted (NO in step S405), controller 31 moves the process to step S109. Since the subsequent process is similar to that of the first process example, description will not be repeated.

FIG. 12 is a diagram for illustrating data D12.

Referring to FIG. 12, in data D12, information indicating whether or not to perform a prescribed process is associated with each paper type. Examples of the prescribed process include “shifting”, “punching”, “stapling”, “center folding/saddle stitching”, “double-sided printing”, and “color printing”.

As described above, in this example, the print job is continued when the positive determination is made in step S405, and the print job is suspended and the warning is displayed when the negative determination is made in step S405.

(Intention of Process)

For example, in the case of the combinations shown in data D12, even if stapling is set as the print setting at the start of the print job when the paper type set by operation panel 34 is “thick paper #1”, the combination of the paper type and the print setting is not prohibited. Therefore, image forming apparatus 1 can start the print job. Even when the paper type detected by media sensor 16 subsequently becomes “thick paper #2”, stapling is permitted. Therefore, an output that meets the print setting desired by the user can be obtained. Thus, controller 31 continues the job.

In contrast, when the paper type detected by media sensor 16 becomes “thick paper #3”, stapling is not permitted. That is, image forming apparatus 1 cannot perform stapling in postprocessor 20. In this case, controller 31 cannot determine whether or not to cancel the stapling mode without permission. Thus, image forming apparatus 1 causes operation panel 34 to display the warning, in order to ask for user's judgment.

### c5. Fifth Process Example

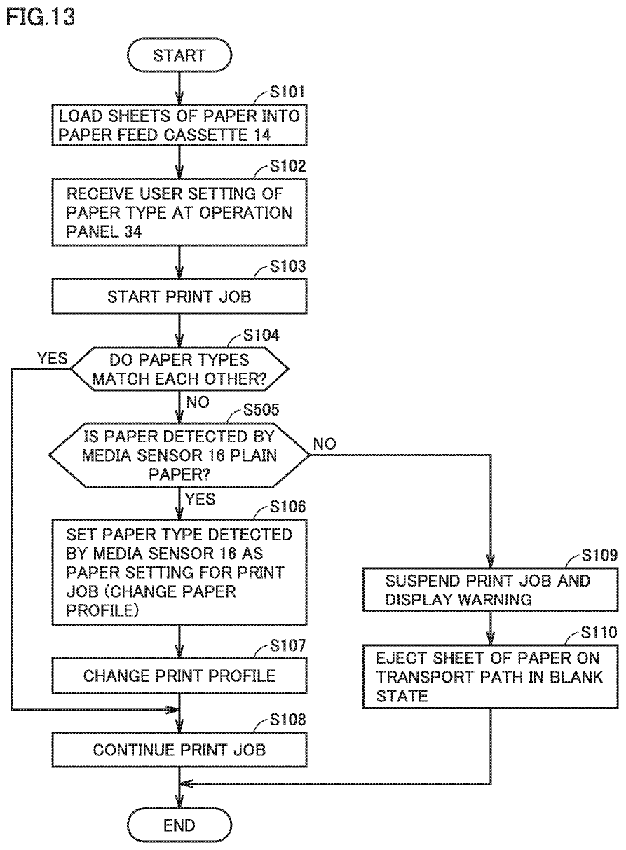

FIG. 13 is a flowchart for illustrating a fifth process example.

Referring to FIG. 13, the fifth process example is different from the first process example in that the fifth process example includes step S505 instead of step S105. Therefore, in the following description, attention will be focused on step S505 and description of the remaining steps will not be repeated.

When it is determined that the paper type set by operation panel 34 does not match the paper type detected by media sensor 16 (NO in step S104), controller 31 determines whether or not the predetermined condition is met in step S505. Specifically, in step S505, controller 31 determines whether or not the paper detected by media sensor 16 is plain paper.

When it is determined that the paper detected by media sensor 16 is the plain paper (i.e., it is determined that the predetermined condition is met) (YES in step S505), controller 31 moves the process to step S106. When it is determined that the paper detected by media sensor 16 is not the plain paper (NO in step S505), controller 31 moves the process to step S109. Since the subsequent process is similar to that of the first process example, description will not be repeated.

As described above, in this example, the print job is continued when the positive determination is made in step S505, and the print job is suspended and the warning is displayed when the negative determination is made in step S505.

(Intention of Process)

The plain paper is commonly used in an office. Therefore, the possibility of causing a miscopy seems to be low. Even if a miscopy occurs, the plain paper is easily available at relatively low cost. Therefore, the damage seems to be light. Thus, when the paper type detected by media sensor 16 is the plain paper, controller 31 continues the job.

In contrast, the paper types other than the plain paper are special and relatively expensive as compared with the plain paper. Therefore, the damage when a miscopy occurs tends to be great. Thus, when the paper detected by media sensor 16 is not the plain paper, image forming apparatus 1 causes operation panel 34 to display the warning, in order to allow the user to check an intention to use the paper.

### c6. Sixth Process Example

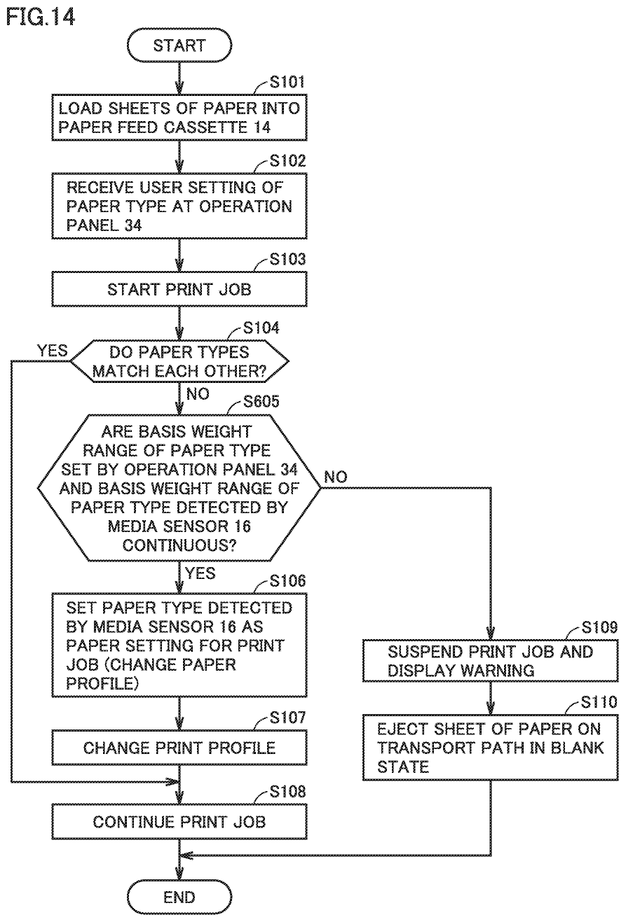

FIG. 14 is a flowchart for illustrating a sixth process example.

Referring to FIG. 14, the sixth process example is different from the first process example in that the sixth process example includes step S605 instead of step S105. Therefore, in the following description, attention will be focused on step S605 and description of the remaining steps will not be repeated.

When it is determined that the paper type set by operation panel 34 does not match the paper type detected by media sensor 16 (NO in step S104), controller 31 determines whether or not the predetermined condition is met in step S605. Specifically, in step S605, controller 31 determines whether or not a basis weight range of the paper type set by operation panel 34 and a basis weight range of the paper type detected by media sensor 16 are continuous, based on data D6 (see FIG. 6).

The basis weight ranges being continuous indicates that the ranges are continuous, such as, for example, “52 to 59 g/m²” and “60 to 90 g/m²”. In other words, the basis weight ranges being continuous indicates that a basis weight range of another paper type is not included between the basis weight range of the paper type set by operation panel 34 and the basis weight range of the paper type detected by media sensor 16.

For example, when the basis weight range of the paper type set by operation panel 34 is “60 to 90 g/m²” and the basis weight range of the paper type detected by media sensor 16 is “106 to 120 g/m²”, the basis weight ranges are not continuous because the range of “91 to 105 g/m²” (range of plain paper+) is present.

When it is determined that the basis weight ranges are continuous (i.e., it is determined that the predetermined condition is met) (YES in step S605), controller 31 moves the process to step S106. When it is determined that the basis weight ranges are not continuous (NO in step S605), controller 31 moves the process to step S109. Since the subsequent process is similar to that of the first process example, description will not be repeated.

As described above, in this example, the print job is continued when the positive determination is made in step S605, and the print job is suspended and the warning is displayed when the negative determination is made in step S605.

(Intention of Process)

In image forming apparatus 1, as shown in data D6 in FIG. 6, the paper type is classified in detail according to the basis weight, such that printing can be performed on various types of paper at optimum print profiles.

However, although a general user can recognize that the paper is thick paper, it is difficult for the general user to determine whether it corresponds to thick paper #2 (158 to 209 g/m²) or thick paper #3 (210 to 256 g/m²). Furthermore, in the environment where different image forming apparatuses 1 are used, the paper classified into thick paper #2 in one image forming apparatus 1 may be classified into thick paper #3 in another image forming apparatus.

In contrast, a difference between plain paper (60 to 90 g/m²) and thick paper #4 (257 to 300 g/m²) is visually recognizable. In addition, as a result of the determination process in step S605 described above, it is determined that a basis weight range of the paper such as the plain paper and a basis weight range of the special paper such as the envelope/OHP are not continuous.

Thus, when the basis weight ranges are continuous, image forming apparatus 1 determines that the user could not simply determine the paper type and the user still wants to use the sheets of paper loaded by the user, and continues the job. In contrast, when the basis weight ranges are not continuous (when the paper type is distinctly different), image forming apparatus 1 causes operation panel 34 to display the warning, in order to ask the user.

### c7. Seventh Process Example

Image forming apparatus 1 receives an operation for selecting whether to give a higher priority to the result of detection by media sensor 16 (i.e., the result of the paper type automatic detection function) or to give a higher priority to the setting (user setting) of the paper type through operation panel 34. The operation can be typically received at an operation screen of an administrator setting (administrator mode) of image forming apparatus 1.

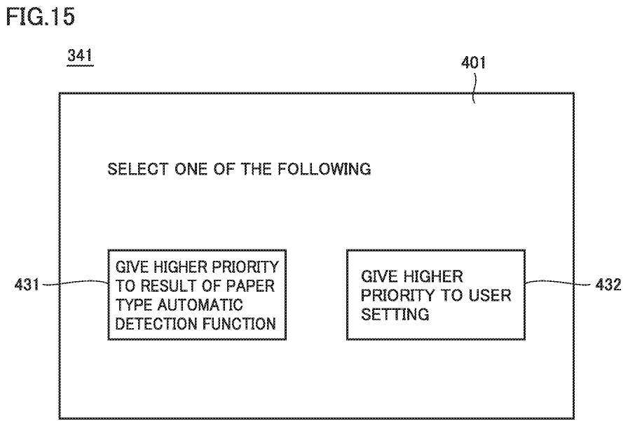

FIG. 15 shows an example operation screen of an administrator setting.

Referring to FIG. 15, when an administrator enters a password and the like through operation panel 34 and performs a prescribed operation, a screen 401 is displayed on operation panel 34. Screen 401 includes an object image 431 for making a setting of giving a higher priority to the result of the paper type automatic detection function, and an object image 432 for making a setting of giving a higher priority to the user setting.

When the administrator selects one of object image 431 and object image 432, the setting associated with the selected object image is made. The contents of the setting are stored in storage unit 550 (see FIG. 7) as the priority information.

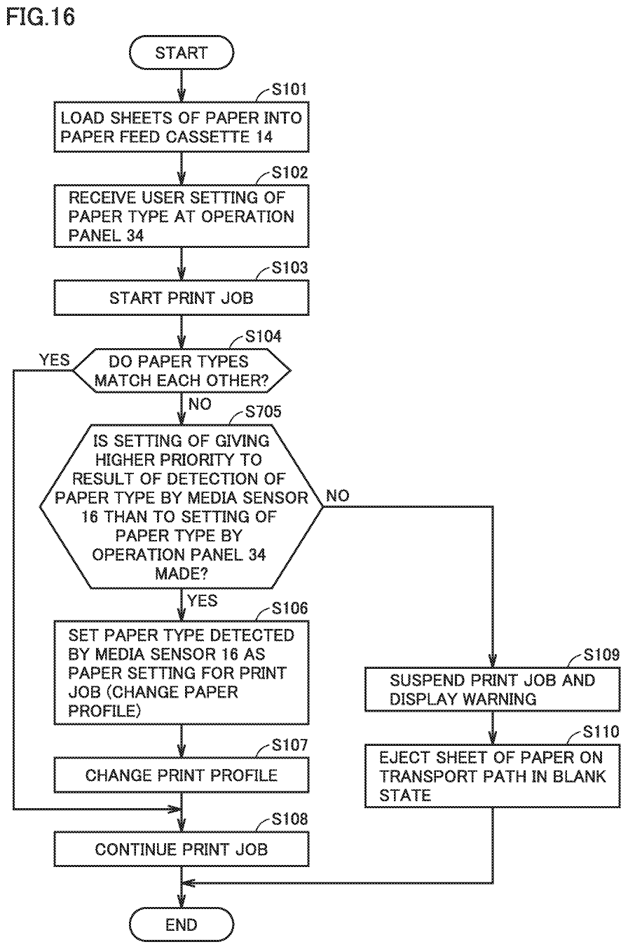

FIG. 16 is a flowchart for illustrating a seventh process example.

Referring to FIG. 16, the seventh process example is different from the first process example in that the seventh process example includes step S705 instead of step S105. Therefore, in the following description, attention will be focused on step S705 and description of the remaining steps will not be repeated.

When it is determined that the paper type set by operation panel 34 does not match the paper type detected by media sensor 16 (NO in step S104), controller 31 determines whether or not the predetermined condition is met in step S705. Specifically, in step S705, controller 31 refers to the priority information and determines whether or not the setting of giving a higher priority to the result of detection of the paper type by media sensor 16 than to the setting of the paper type by operation panel 34 is made.

When it is determined that a higher priority is given to the result of detection of the paper type by media sensor 16 (i.e., it is determined that the predetermined condition is met) (YES in step S705), controller 31 moves the process to step S106. When it is determined that a higher priority is given to the setting of the paper type by operation panel 34 (NO in step S705), controller 31 moves the process to step S109. Since the subsequent process is similar to that of the first process example, description will not be repeated.

As described above, in this example, the print job is continued when the positive determination is made in step S705, and the print job is suspended and the warning is displayed when the negative determination is made in step S705.

(Intention of Process)

A user who trusts the result of detection by the paper type automatic detection function may feel it troublesome to set the paper type on operation panel 34 when loading the sheets of paper into paper feed cassette 14. In such a case, the use of the result of detection by media sensor 16 is preset. With this setting, the user does not need to set the paper type consciously when loading the sheets of paper into paper feed cassette 14. Therefore, image forming apparatus 1 applies the result of detection by media sensor 16 and continues the job.

In contrast, some users want to check the result of detection by media sensor 16 and then think about a subsequent action. When there are such users, the administrator may select the user setting. In this case, image forming apparatus 1 causes operation panel 34 to display the warning when the paper types do not match each other.

### c8. Eighth Process Example

Image forming apparatus 1 can set one of a mode of making a charge (hereinafter, referred to as “charging mode”) and a mode of not making a charge. When image forming apparatus 1 is used in a store or the like, the administrator sets the charging mode, to thereby make a charge for the use of image forming apparatus 1 by the user in accordance with, for example, the number of copies.

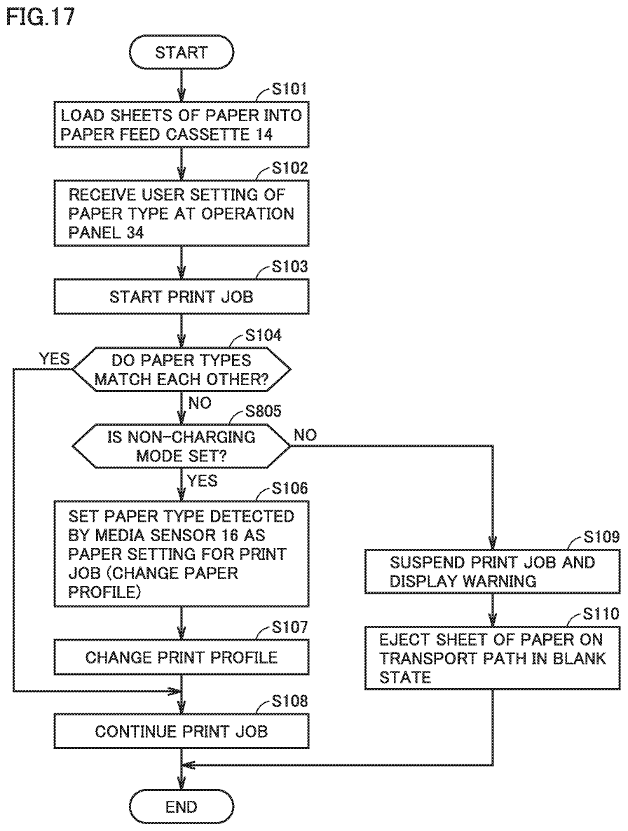

FIG. 17 is a flowchart for illustrating an eighth process example.

Referring to FIG. 17, the eighth process example is different from the first process example in that the eighth process example includes step S805 instead of step S105. Therefore, in the following description, attention will be focused on step S805 and description of the remaining steps will not be repeated.

When it is determined that the paper type set by operation panel 34 does not match the paper type detected by media sensor 16 (NO in step S104), controller 31 determines whether or not the predetermined condition is met in step S805. Specifically, in step S805, controller 31 determines whether or not the non-charging mode is set.

When it is determined that the non-charging mode is set (i.e., it is determined that the predetermined condition is met) (YES in step S805), controller 31 moves the process to step S106. When it is determined that the charging mode is set (NO in step S805), controller 31 moves the process to step S109. Since the subsequent process is similar to that of the first process example, description will not be repeated.

As described above, in this example, the print job is continued when the positive determination is made in step S805, and the print job is suspended and the warning is displayed when the negative determination is made in step S805.

(Intention of Process)

When image forming apparatus 1 is placed in a store or the like (such as a convenience store or a library) and connected to a vendor apparatus, image forming apparatus 1 operates in the charging mode. When a miscopy occurs in such image forming apparatus 1, the miscopy causes financial damage to the user. Therefore, if there is even a remote possibility of a miscopy during operation of image forming apparatus 1 in the charging mode, image forming apparatus 1 causes operation panel 34 to display the warning, in order to ask for user's judgment.

When image forming apparatus 1 is not operating in the charging mode, image forming apparatus 1 may continue the print job based on the result of detection by media sensor 16.

### c9. Ninth Process Example

In network system 1000 (see FIG. 1), the print job (specifically, the above-described job based on the print command) can be executed from image forming apparatus 1 using PC 3. In PC 3, a setting of the printer driver for image forming apparatus 1 can be made.

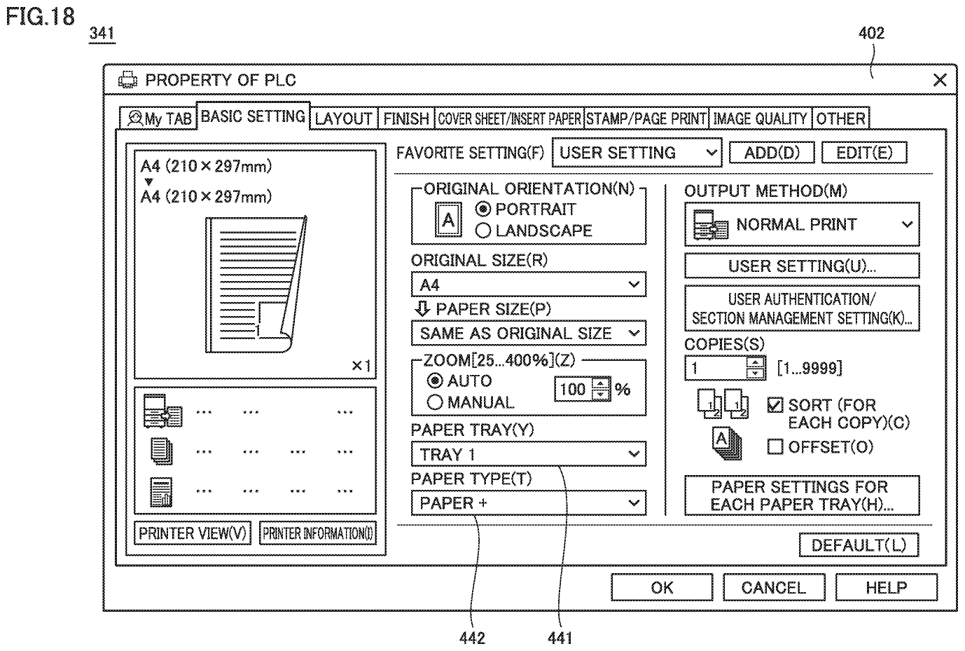

FIG. 18 shows a setting screen of the printer driver displayed on PC 3.

Referring to FIG. 18, a setting screen 402 includes an item 441 for selecting the paper feed cassette, and an item 442 for selecting the paper type. The example in FIG. 18 shows that the user sets the paper type of paper feed cassette 14 at “paper #1+”.

A configuration for also determining whether or not the paper type set by the printer driver matches the paper type detected by media sensor 16 will be described below.

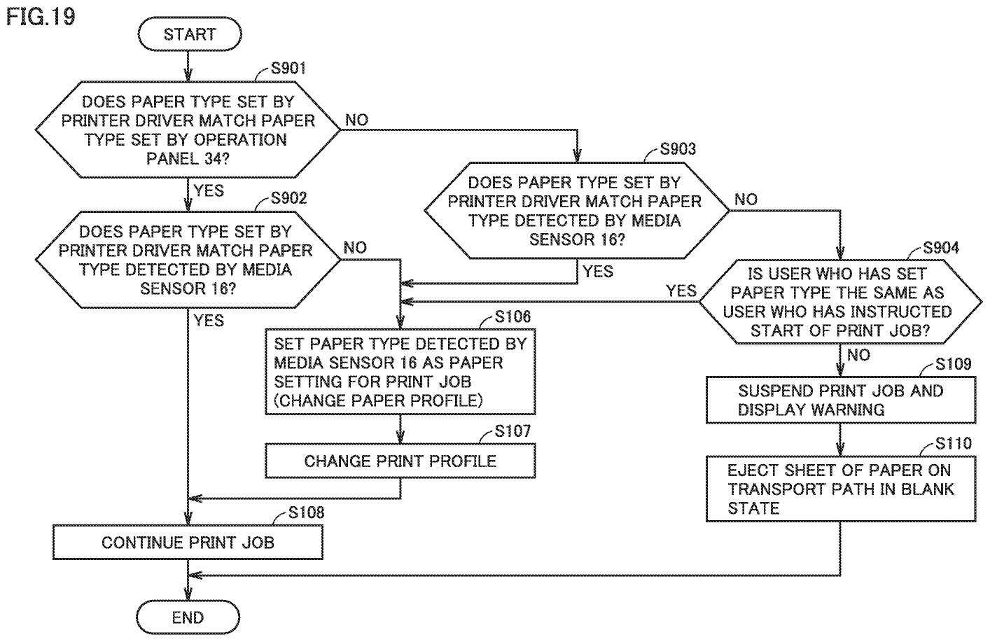

FIG. 19 is a flowchart for illustrating a ninth process example.

Referring to FIG. 19, in step S901, controller 31 determines whether or not a paper type set by the printer driver matches a paper type set by operation panel 34.

When it is determined that the paper type set by the printer driver matches the paper type set by operation panel 34 (YES in step S901), controller 31 determines whether or not the paper type set by the printer driver matches a paper type detected by media sensor 16 in step S902. When it is determined that the paper type set by the printer driver does not match the paper type set by operation panel 34 (NO in step S901), controller 31 moves the process to step S903.

When it is determined that the paper type set by the printer driver matches the paper type detected by media sensor 16 (YES in step S902), controller 31 continues the print job in step S108. When it is determined that the paper type set by the printer driver does not match the paper type detected by media sensor 16 (NO in step S902), controller 31 moves the process to step S106. Thereafter, controller 31 moves the process to step S107. Thereafter, controller 31 further moves the process to step S108.

Similarly to step S902, in step S903, controller 31 determines whether or not the paper type set by the printer driver matches the paper type detected by media sensor 16.

When it is determined that the paper type set by the printer driver matches the paper type detected by media sensor 16 (YES in step S903), controller 31 moves the process to step S106. When it is determined that the paper type set by the printer driver does not match the paper type detected by media sensor 16 (NO in step S903), controller 31 determines whether or not a user who has set the paper type is the same as a user who has instructed the start of the print job in step S904.

When it is determined that the user who has set the paper type is the same as the user who has instructed the start of the print job (YES in step S904), controller 31 moves the process to step S106. When it is determined that the user who has set the paper type is not the same as the user who has instructed the start of the print job (NO in step S904), controller 31 moves the process to step S109. Thereafter, controller 31 moves the process to step S110.

When user authentication is not performed and when it is determined in step S903 that the paper type set by the printer driver does not match the paper type detected by media sensor 16 (NO in step S903), controller 31 moves the process to step S109 without performing step S904.

As described above, in this example, the print job is continued even when the negative determination is made in step S902 and even when the positive determination is made in step S903. That is, when only two of the three types (paper types) match each other and the one remaining type does not match the two, controller 31 determines that the predetermined condition is met, and continues the print job.

When the paper type set by the printer driver, the paper type set by operation panel 34, and the paper type detected by media sensor 16 are different from one another (not shown in FIG. 19), it is preferable to determine that the predetermined condition is not met, and suspend the print job.

Furthermore, when it is determined that the user who has set the paper type by the printer driver is the same as the user who has set the paper type by operation panel 34 and when the paper type set by the printer driver is different from the paper type detected by media sensor 16, it is preferable to determine that the predetermined condition is met, and continue the print job. As described above, the comparison between the paper type set by the printer driver and the paper type detected by operation panel 34 as shown in step S901 is not necessarily essential.

In this example, the case in which the negative determination is made in step S903 includes the following two cases as to whether the paper types are different or the same. The first case is a case in which the paper type set by the printer driver, the paper type set by operation panel 34, and the paper type detected by media sensor 16 are different from one another. The second case is a case in which the paper type set by operation panel 34 is the same as the paper type detected by media sensor 16 and the paper type set by the printer driver is different from the paper type set by operation panel 34 (or the paper type detected by media sensor 16). In both of the first case and the second case, the print job is suspended and the warning is displayed in step S109 when the negative determination is made in step S904.

(Intention of Process)

(1) When the paper type set (specified) on the printer driver is the same as the paper type set by operation panel 34 (i.e., YES in step S901), there is a high possibility that the user who has loaded the sheets of paper into paper feed cassette 14 is the same as the user who has executed the print job.

In this case, when only the paper type detected by media sensor 16 is different from the paper type determined to be the same as described above (i.e., NO in step S902), it is conceivable that the user's assumption brings about the situation in which the type of the actually loaded sheets of paper is different from the paper type set by the user. Therefore, in such a case, image forming apparatus 1 determines that the user wants to use the sheets of paper loaded by the user, and continues the job.

(2) When the paper type set on the printer driver is different from the paper type set by operation panel 34 (i.e., NO in step S901), there is a high possibility that the user who has loaded the sheets of paper is different from the user who has executed the print job.

In this case, a higher priority should be given to the intention of the user who has executed the print job. When the paper type set on the printer driver matches the paper type detected by media sensor 16 (YES in step S903), the sheets of paper intended by the user who has executed the print job are in paper feed cassette 14, and thus, image forming apparatus 1 continues the job.

(3) There is a case in which the paper type set on the printer driver is different from the paper type detected by media sensor 16 (NO in step S903) and the paper type set by operation panel 34 matches the paper type detected by media sensor 16. In such a case, it is conceivable that although the user who has loaded the sheets of paper into paper feed cassette 14 has set the paper type correctly, another user has set another paper type and executed the print job.

In this case, there is a high possibility that an output desired by the user who has started (submitted) the print job is not obtained. Thus, image forming apparatus 1 causes operation panel 34 to display the warning, to thereby leave a judgment to the user who has submitted the print job.

(4) There is also a case in which the paper type set on the printer driver is different from the paper type detected by media sensor 16 (NO in step S903) and the paper type set by operation panel 34 is different from the paper type detected by media sensor 16. In this case as well, there is a high possibility that an output desired by the user who has submitted the print job is not obtained. Thus, image forming apparatus 1 causes operation panel 34 to display the warning, to thereby leave a judgment to the user who has started the print job.

(5) When user authentication is performed, it can be determined whether or not the user who has instructed the start of the print job is the same as the user who has set the paper type through operation panel 34 (step S904). In this case, even when the paper type set on the printer driver is different from the paper type set by operation panel 34, image forming apparatus 1 gives a highest priority to the user's intention to use the sheets of paper prepared and loaded by the user, when the user who has instructed the start of the print job is the same as the user who has set the paper type through operation panel 34 as a result of user authentication. Therefore, image forming apparatus 1 continues the job.

In the present embodiment, a series of process by control unit 500 is typically implemented by CPU 311 executing a program (installed program) prestored in image forming apparatus 1.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An image forming apparatus comprising:
a paper feed cassette;
an operation panel that sets a type of a sheet loaded into the paper feed cassette;
a sensor that detects the type of the sheet; and
a controller that controls execution of a print job, wherein
the controller
determines whether or not a sheet type set by the operation panel matches a sheet type detected by the sensor,
when determining that the sheet types do not match each other, determines whether or not a predetermined condition is met,
when the predetermined condition is met, continues the print job at a setting corresponding to the sheet type detected by the sensor, and
when the predetermined condition is not met, suspends the print job.

2. The image forming apparatus according to claim 1, wherein
when the predetermined condition is not met, the controller causes the operation panel to display a warning.

3. The image forming apparatus according to claim 1, wherein
the operation panel receives an operation for instructing a start of the print job, and
the predetermined condition is that the operation panel receives the operation for instructing the start of the print job, before a predetermined time period elapses after the sheet is loaded into the paper feed cassette and the sheet type is set by the operation panel.

4. The image forming apparatus according to claim 1, wherein
when the sheet is loaded into the paper feed cassette after the paper feed cassette becomes out of sheet, and the print job is restarted, the controller determines that the predetermined condition is not met.

5. The image forming apparatus according to claim 1, wherein
when the print job is a job of printing a plurality of number of copies in units of copies, the predetermined condition is that the paper feed cassette is replenished with the sheet from a state in which the paper feed cassette is empty, and the print job is restarted from the beginning of one of the copies.

6. The image forming apparatus according to claim 1, wherein
the controller performs user authentication, and
the predetermined condition is that it is determined as a result of the user authentication that a user who has set the sheet type by the operation panel is the same as a user who has instructed a start of the print job.

7. The image forming apparatus according to claim 1, wherein
the predetermined condition is that a combination of the sheet type detected by the sensor and a setting of the print job is not prohibited.

8. The image forming apparatus according to claim 1, wherein
the predetermined condition is that the sheet type detected by the sensor is plain paper.

9. The image forming apparatus according to claim 1, further comprising
a memory that stores data defining the sheet type based on a basis weight range, wherein
the predetermined condition is that a basis weight range of the sheet type set by the operation panel and a basis weight range of the sheet type detected by the sensor are continuous.

10. The image forming apparatus according to claim 1, wherein
the controller receives a setting of giving a higher priority to one of a setting of the sheet type by the operation panel and a result of detection of the sheet type by the sensor than to the other, and
the predetermined condition is that a setting of giving a higher priority to the result of detection of the sheet type by the sensor than to the setting of the sheet type by the operation panel is made.

11. The image forming apparatus according to claim 1, wherein
the image forming apparatus has, as setting modes, a first mode of executing the print job under condition of charging, and a second mode of executing the print job without condition of charging, and
the predetermined condition is that the setting mode is the second mode.

12. An image forming apparatus comprising:
a paper feed cassette;
an operation panel that sets a type of a sheet loaded into the paper feed cassette;
a sensor that detects the type of the sheet; and
a controller that executes a print job by a printer driver of an external information processing apparatus,
wherein
the controller
determines whether or not all of a sheet type set by the printer driver, a sheet e set by the operation panel, and a sheet type detected by the sensor match one another,
when determining that all of the sheet types do not match one another, determines whether or not a predetermined condition is met,
when the predetermined condition is met, continues the print job at a setting corresponding to the sheet type detected by the sensor, and
when the predetermined condition is not met, suspends the print job.

13. The image forming apparatus according to claim 12, wherein
when the predetermined condition is not met, the controller causes the operation panel to display a warning.

14. The image farming apparatus according to claim 12, wherein
the predetermined condition is that only two of all of the sheet types match each other and one remaining sheet type does not match the two.

15. The image forming apparatus according to claim 12, wherein
when the sheet type set by the printer driver, the sheet type set by the operation panel, and the sheet type detected by the sensor are different from one another, the controller determines that the predetermined condition is not met.

16. The image forming apparatus according to claim 12, wherein
the controller performs user authentication, and
the predetermined condition is that it is determined as a result of the user authentication that a user who has set the sheet type by the printer driver is the same as a user who has set the sheet type by the operation panel, and the sheet type set by the printer driver is different from the sheet type detected by the sensor.

17. An image forming system comprising an image forming apparatus and an information processing apparatus, wherein
the information processing apparatus includes a printer driver for the image forming apparatus,
the image forming apparatus includes:
a paper feed cassette;
an operation panel that sets a type of a sheet loaded into the paper feed cassette;
a sensor that detects the type of the sheet; and
a controller that executes a print job by the printer driver,
the controller
determines whether or not all of a sheet type set by the printer driver, a sheet type set by the operation panel, and a sheet type detected by the sensor match one another,
when determining that all of the sheet types do not match one another, determines whether or not a predetermined condition is met,
when the predetermined condition is met, continues the print job at a setting corresponding to the sheet type detected by the sensor, and
when the predetermined condition is not met, suspends the print job.

18. An image forming apparatus comprising:
an operation panel; and
a controller, wherein
the controller receives an input for setting a type of a sheet through the operation panel, even when a function of automatically detecting the type of the sheet is on.

19. The image forming apparatus according to claim 18, further comprising:
a paper feed cassette that accommodates the sheet; and
a sensor that automatically detects the type of the sheet, wherein
the operation panel receives a setting of the type of the sheet loaded into the paper feed cassette, and
the controller receives, through the operation panel, an input for turning on the function and an input for turning off the function.

20. A method for controlling an image forming apparatus, the method comprising:
determining whether or not a sheet type set by an operation panel matches a sheet type detected by a sensor;
when determining that the sheet types do not match each other, determining whether or not a predetermined condition is met;
when the predetermined condition is met, continuing a print job at a setting corresponding to the sheet type detected by the sensor; and
when the predetermined condition is not met, suspending the print job.

21. A method for controlling an image forming apparatus, the method comprising:
determining whether or not all of a sheet type set by a printer driver of an information processing apparatus communicatively connected to the image forming apparatus, a sheet type set by an operation panel, and a sheet type detected by a sensor match one another;
when determining that all of the sheet types do not match one mother, determining whether or not a predetermined condition is met;
when the predetermined condition is met, continuing a print job at a setting corresponding to the sheet type detected by the sensor; and
when the predetermined condition is not met, suspending the print job.
